(19) United States
(12) Patent Application Publication
(10) Pub. No.: US 2014/0284823 A1
(43) Pub. Date: Sep. 25, 2014

(54) AERATOR AND METHOD FOR AERATING A LIQUID

(71) Applicant: SCOTT FRASER, OAK HARBOR, WA (US)

(72) Inventor: SCOTT FRASER, OAK HARBOR, WA (US)

(21) Appl. No.: 14/222,479

(22) Filed: Mar. 21, 2014

Related U.S. Application Data
(60) Provisional application No. 61/804,321, filed on Mar. 22, 2013.

(51) Int. Cl. B01F 3/04

(52) U.S. Cl. CPC B01F 3/04787
USPC 261/108

(57) ABSTRACT

An aerator may be inserted into the neck of a wine bottle to aerate the wine as it is poured from the bottle. A cavity created in the distal end of the bottle as the wine is dispensed is vented to aid in high flow rate. The aerator seals against the inside surface of a typical wine bottle, and regulates pressures to create high flow and a high degree of aeration throughout the full dispense cycle of wine from the bottle.

### PRIORITY CLAIM

This application claims priority to U.S. Provisional Patent Application Ser. No. 61/804,321 filed Mar. 22, 2013. The foregoing application is hereby incorporated by reference as if fully set forth herein.

### FIELD OF THE INVENTION

The present invention related generally to aerators, and more specifically to aerators used for decanting wine from a bottle.

### BACKGROUND OF THE INVENTION

Many types of red and white wines have noticeably improved taste after they have been allowed to interact with oxygen. This can be accomplished through many techniques. A wine bottle can be allowed to sit for an extended period of time after it has been opened. Or wine can be swirled in a glass to accelerate the introduction of air to the wine. Wine can also be poured through a device specifically designed to mix air with the wine, such the device depicted in U.S. Pat. No. 6,568,660. These methods and devices require a fair amount of time to let the wine breathe.

Accordingly, there is a need for a method and device to add as much air as possible to wine as quickly as possible as it is being poured from a bottle into a glass as quickly as possible while providing enough interaction with oxygen to allow the wine to breathe and taste as good as possible in a relatively short period of time.

### SUMMARY OF THE INVENTION

In accordance with a preferred embodiment, the invention ma be inserted into the neck of a wine bottle and aerates the wine as it is poured from the bottle. The cavity created in the distal end of the bottle as the wine is dispensed is vented to aid in high flow rate. The aerator seals against the inside surface of a typical wine bottle, and regulates pressures to create high flow and a high degree of aeration throughout the full dispense cycle of wine from the bottle.

### BRIEF DESCRIPTION OF THE DRAWINGS

Preferred and alternative examples of the present invention are described in detail below with reference to the following drawings:

FIG. 1 is an isometric front view of an aerator according to a preferred embodiment of the present invention;

FIG. 2 is an isometric rear view of the aerator of FIG. 1;

FIG. 3A is a front view of the aerator of FIG. 1 positioned in a typical wine bottle;

FIG. 3B is a sectional side view of the aerator of FIG. 3A;

FIG. 4A is a front view of the aerator of FIG. 1 showing sectional line D-D;

FIG. 4B is a sectional side view along line D-D of the aerator of FIG. 4A illustrating a venturi air intake;

FIG. 5A is a front view of the aerator of FIG I showing sectional line E-E;

FIG. 5B is a sectional side view along line E-E of the aerator of FIG. 5A illustrating a bottle vent air passage;

FIG. 6 is a sectional side view of the aerator according to a preferred embodiment prior to insertion of the aerator into a bottle:

FIG. 7 is a sectional side view of the aerator according to a preferred embodiment after insertion of the aerator into a bottle;

FIG. 8 is a close-up of a portion of the sectional side view of FIG. 3B;

FIG. 9 is a portion of the sectional side view of FIG. 3B;

FIG. 10 is an isometric front view of an aerator according to an alternative embodiment of the present invention;

FIG. 11 is an isometric rear view of the aerator of FIG. 9;

FIG, 12 is a sectional side view of the alternative embodiment of the aerator of the present invention; and

FIG. 13 isometric rear view of an aerator according to yet another alternative embodiment of the present invention illustrating an alternative vent tube mounting configuration.

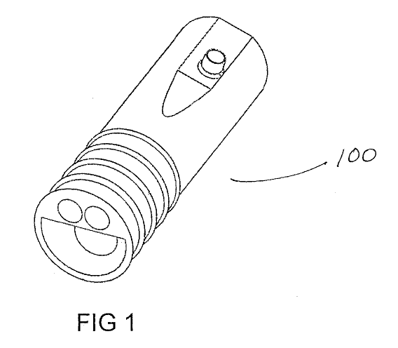

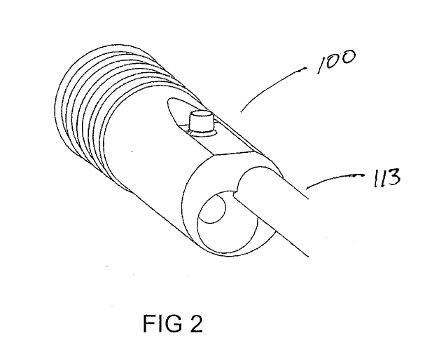

### DETAILED DESCRIPTION OF THE PREFERRED EMBODIMENT

Features of a preferred embodiment of the invention include at least one vent tube, a method for attaching vent tubes, a venturi for aeration, at least one venturi air intake channels, a method for creating and sealing venturi air intake channels, features to create a seal with the neck of a typical wine bottle, and a lip to prevent the aerator device from being driven too deep and allowing it to essentially free float in the bottle.

A vent tube runs from the proximal neck end of the bottle to the distal end of the bottle and is used allow the cavity created from escaping wine to be vented to atmospheric pressure. This prohibits a pressure vacuum from forming in the bottle which would inhibit full flow through the aerator. This vent tube allows the wine to pour at the highest possible rate. The length and diameter of this tube has a significant impact on the performance of the flow rate.

As with any venturi, the air intake orifice is nearly normal to the venturi channel. The high velocity fluid passing through the smaller diameter channel in the venturi causes low pressure, which allows the introduced higher pressure air to be forced into the fluid, thus aerating the wine.

The venturi air intake passages originate from the outer proximal exposed face of the aerator, runs parallel to the centerline of the bottle, make a 90 degree turn and end up nearly normal to the venturi channel.

Typical wine bottles have a frustoconical shaped neck. As a cylindrical device is inserted into a typical neck, the inner wall of the bottle diverges from the cylindrical surface of the device being inserted. In accordance with a preferred embodiment, the present invention allows for sealing against the inside surface of a typical wine bottle neck. As will be discussed more completely below, multiple redundant seal ribs on the aerator seal against the inside surface of the bottle so that fluid (e.g., wine) does not leak out and air does not enter the bottle.

Also the inside diameter of the frustoconical shaped wine bottle necks are not consistent. The preferred embodiment of this invention provides for seals with adequate compliance to allow for sealing to a wide range of inner diameters of necks.

Similar to patent application US2012/0074092A1 this device can also be installed during the bottling process or after the bottle has been opened.

Furthermore, due to the fluid dynamics of the fluid dispensing process and the related orientation of the orifices in the aerator, the aerator according to a preferred embodiment is configured to make it clear to the person pouring the wine just how the aerator needs to be oriented relative to the wine glass.

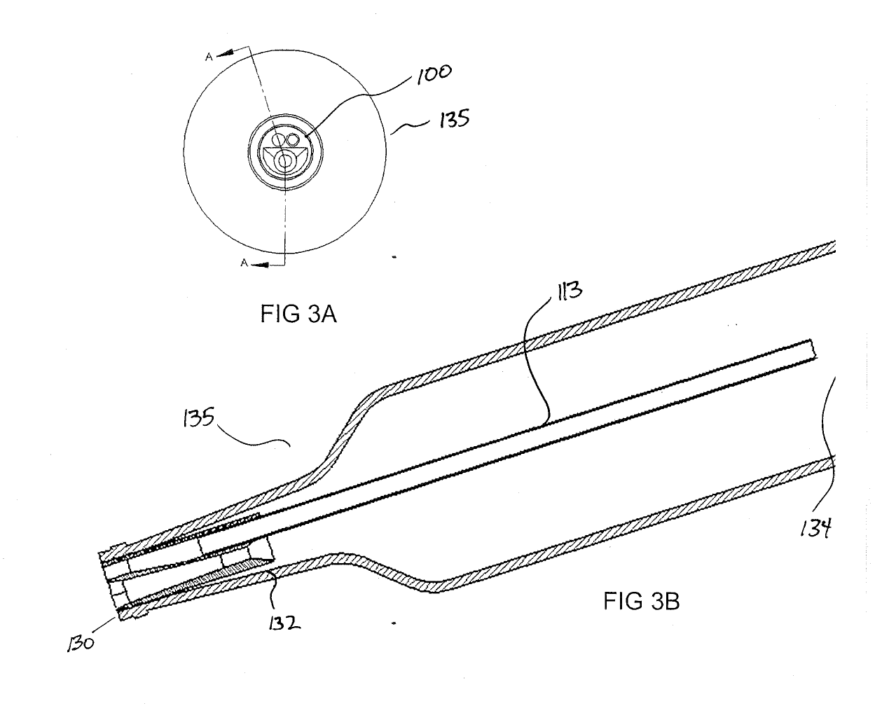

Turning now to the figures, and specifically as seen in FIGS. 3B and 11, the aerators 100 or 200 are fully installed into a typical wine bottle or other container to enable existing bottling/capping processes at the bottling facility to be utilized. Aerators 100 and 200 can also be installed after a screw cap or cork has been removed. They also allow for a screw cap to be re-installed for storing the remaining contents in the bottle.

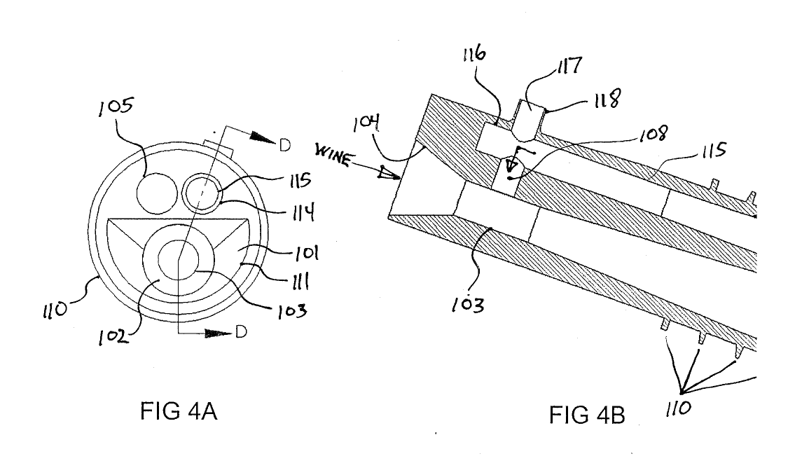

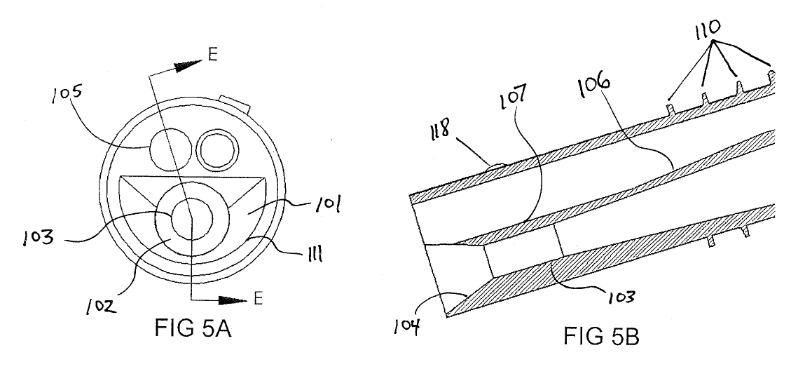

In FIG. 4B when the bottle 135 is tipped for pouring, the wine flows from venturi intake 104 through venturi throat 103 and out of venturi exhaust 102. The flow rate is the same throughout this passage; therefore the fluid is forced to speed up as it passes through venturi throat 103. This increase in speed causes a pressure decrease relative to atmospheric air pressure. Air at venturi air intake 108, which is at atmospheric pressure, is then pulled into the lower pressure fluid stream. This action causes air to be intermixed with the wine and therefore improves its taste. The air at the venturi air intake 108 originates at face 112 and travels through a straight or tapered passage 114, then through passage 115, and finally through venturi air intake 108.

This Aerator could be made from any number materials including steel, stainless steel, ceramic, glass, elastomer, or polymer. Preferably the aerator 100 would be made in an economical manner, using for example, injection molding of a single monolithic plastic part, such as polyethylene plastic. However, other methods and materials are possible and may be suitable.

In FIG. 3B when the bottle 135 is tipped for pouring, bottle vent tube 113 allows the bottom of bottle 133 to be vented to atmospheric pressure (as the wine travels through venturi throat 103 due to gravitational force). This prevents a vacuum from occurring, which would retard the flow of fluid and reduce the aeration performance through venturi throat 103. This method of venting allows the full contents of the bottle to be dispensed with the full aeration action at venturi throat 103.

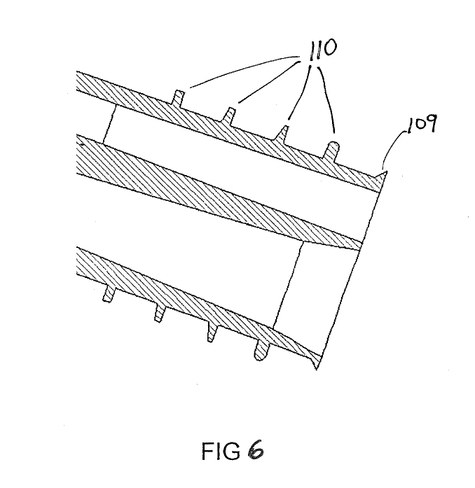

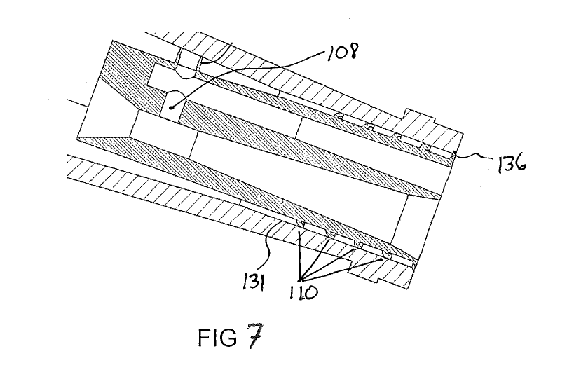

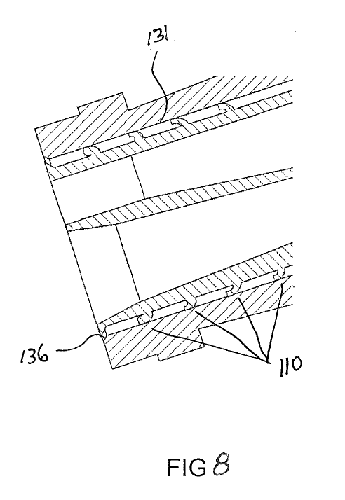

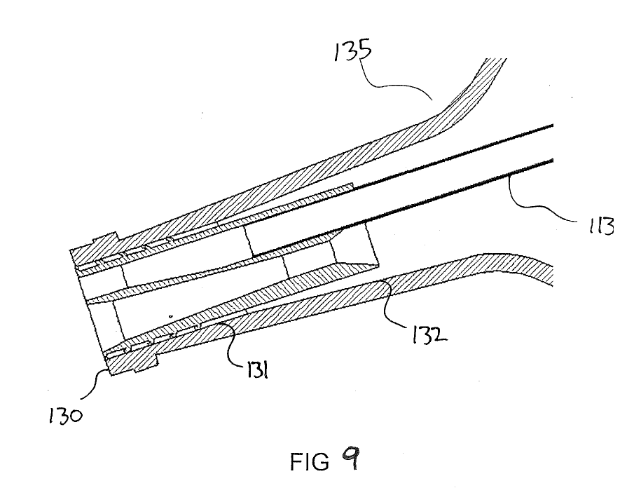

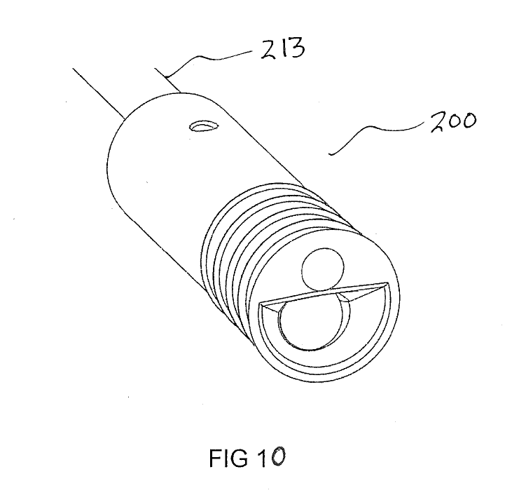

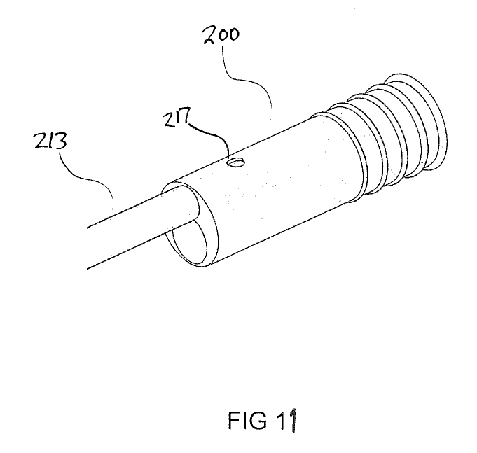

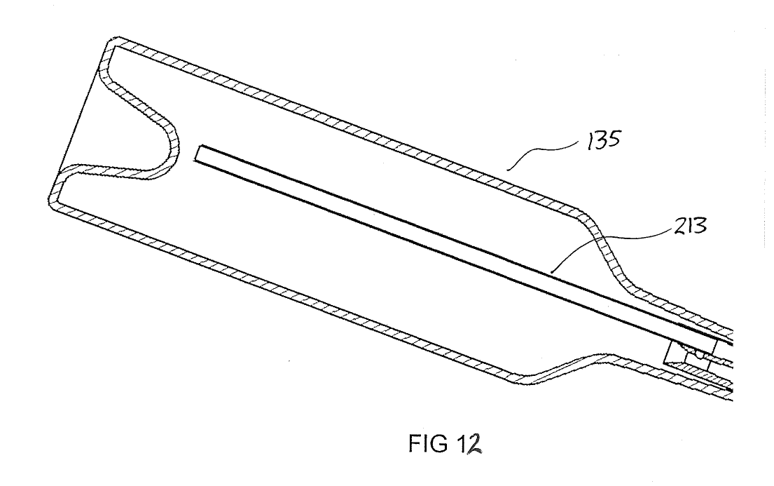

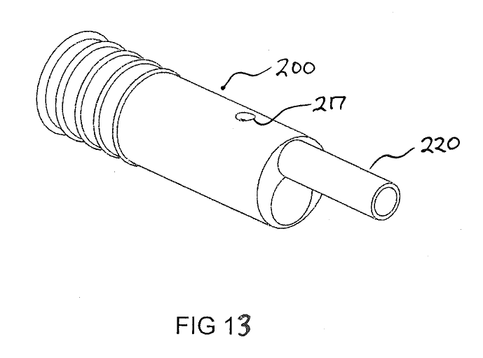

In order to seal aerator 100 to the frustoconical inner wall 131 of the bottle 135, seal ribs 110 are disclosed in FIG. 8. These ribs are designed to allow sealing on a wide range of inner wall 131 diameters. As the aerator 100 is inserted into the bottle the inner wall 131 forces the seals into the shape as seen in FIG. 6. The seal ribs 110 could be a number of different shapes with tapers or fillets or chamfers to give the required maximum deflection without exceeding the yield strength of the material and creating cracks in the bottle.

A lip 109 serves to scat the aerator 100 to the chamfer 236 incorporated into most wine bottles 135, as seen in FIG. 4B. This helps to create a fluidic seal of aerator 100 or aerator 200 to bottle 135 as well as it prevents aerator 100 or aerator 200 from being over driven into the bottle and allowed to float freely.

Spout 111 is used to give a visual clue for proper aerator 100 orientation relative gravitational force. This allows the wine to be dispensed with the best aeration performance, see FIG. 4A.

Instead of bottle vent tube 213 installed into the aerator 200, a boss 220 could be utilized to fit into the inside of bottle vent tube 213, as seen in FIG. 12

Bottle vent tube 213 or 113 could be molded into aerator 100 or aerator 200 to create a single integrated piece.

Vent tube 113 could be longer or shorter than what is shown. Vent tube 113 could be positioned off center near bottle bottom 133.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. An aerator for aerating a liquid as it is dispensed from a container comprising:
a body for insertion into a liquid-containing container and having a channel for dispensing the liquid from the container; and,
a vent channel at least partially within the body and suitable for extending there from into the container and venting a cavity in the container formed as the liquid is dispensed.
